(19) United States
(12) Patent Application Publication
(10) Pub. No.: US 2021/0277532 A1
(43) Pub. Date: Sep. 9, 2021

(54) ELECTROLYTIC CELL ASSEMBLIES AND METHODS FOR PERIODIC VERTICAL DISPLACEMENT

(71) Applicant: PULTRUSION TECHNIQUE INC., Saint-Bruno-de-Montarville (CA)

(72) Inventor: Robert DUFRESNE, Saint-Bruno-de-Montarville (CA)

(21) Appl. No.: 16/321,617

(22) PCT Filed: Jul. 31, 2017
(86) PCT No.: PCT/CA2017/050917

§ 371 Date: Jan. 29, 2019

Related U.S. Application Data
(60) Provisional application No. 62/368,432, filed on Jul. 29, 2016.
(60) Provisional application No. 62/431,951, filed on Dec. 9, 2016.

(51) Int. Cl. C25C 7/06

(52) U.S. Cl. CPC C25C 7/06

(57) ABSTRACT

An electrolytic cell assembly for hydrometallurgical refining of metal and related method for lifting thereof. The cell assembly comprises a rectangular base for contacting a floor; four walls extending upward from the rectangular base and defining an electrolysis cavity for receiving electrolyte and electrodes; anchor apertures provided through the base and/or the walls for providing anchor points for lifting the electrolytic cell assembly off of the floor; and plugs and/or protective layer for plugging and/or covering the anchor apertures to seal the electrolysis cavity during hydrometallurgical refining.

### TECHNICAL FIELD

The technical field generally relates to hydrometallurgical refining of metals and equipment used therein.

### BACKGROUND

Electrolytic cells for hydrometallurgical refining of metals are conventionally provided adjacent to one another, often in side-to-side relation. In between adjacent electrolytic cells there may be cement, adhesive, mortar, or simply a small void space. When void space is present in between adjacent electrolytic cells, significant residues or deposits can crystallize and accumulate. In addition, in some scenarios the cells may experience “creep phenomenon” over time due to the characteristics of the cells' composition, where the cells may expand over time and thus reduce the size of the gap in between adjacent cells.

When an electrolytic cell has to be replaced, maintained or cleaned, there may be insufficient space in between adjacent electrolytic cells to pass the desired cables, curtains or other equipment as the space is too small (e.g., 10-15 mm).

There is a number of challenges related to handling electrolytic cells that are located or positioned in close proximity to each other or with respect to walls or other hindrances.

### SUMMARY

The present techniques respond to the above need by providing lifting means and related lifting method to an electrolytic cell.

In a first implementation, there is provided an electrolytic cell assembly for hydrometallurgical refining of metal, comprising: a rectangular base for contacting a floor; four walls extending upward from the rectangular base and defining an electrolysis cavity for receiving electrolyte and electrodes; anchor apertures provided through the base and/or the walls for providing anchor points for lifting the electrolytic cell assembly off of the floor; and a protective layer for covering the anchor apertures to seal the electrolysis cavity during hydrometallurgical refining.

In another implementation, there is provided an electrolytic cell assembly for hydrometallurgical refining of metal, comprising: a rectangular base for contacting a floor; four walls extending upward from the rectangular base and defining an electrolysis cavity for receiving electrolyte and electrodes; anchor apertures provided through the base and/or the walls for providing anchor points for lifting the electrolytic cell assembly off of the floor; and plugs for plugging the anchor apertures to seal the electrolysis cavity during hydrometallurgical refining.

In another implementation, there is provided an electrolytic cell assembly for hydrometallurgical refining of metal. The electrolytic cell assembly includes an electrolytic cell having a rectangular base for contacting a floor, and four walls extending upward from the rectangular base and defining an electrolysis cavity for receiving electrolyte and electrodes. The electrolytic cell assembly further includes at least two anchor assemblies for lifting the electrolytic cell assembly off of the floor, each anchor assembly comprising an anchor aperture located in the base and/or the walls for providing anchor points.

Optionally, the electrolytic cell assembly may include four anchor assemblies distributed at four corners of the rectangular base. Optionally, the electrolytic cell assembly may include at least one anchor aperture through each wall.

In some implementations, each anchor assembly further includes a protective layer for covering at least the anchor aperture and sealing the electrolysis cavity during hydrometallurgical refining. Each anchor assembly may alternatively or additionally include a plug for plugging the anchor aperture and sealing the electrolysis cavity during hydrometallurgical refining.

In some implementations, the protective layer further extends on surrounding wall and/or base. The protective layer may be made of laminated material. Optionally, the protective layer may include at least one sub-layer of an anticorrosive material.

In some implementations, the anchor aperture may include a central opening used to inert lifting elements; and a reinforcement structure defining the central opening.

The anchor aperture may have a substantially hourglass shape. The anchor aperture may also have an upper portion having a frusto-conical shape tapering outward in the upward direction. Optionally, the anchor aperture has a lower portion having a cylindrical opening.

The plug may have a body portion with an outer surface that contacts the corresponding anchor aperture in a fluid-sealing fashion. Optionally, the body portion comprises rubber material, polymer concrete, fiberglass (e.g., Fiberglas™) reinforced epoxy, Teflon, bisphenol F resin, and/or vinylester Fiberglas™ optionally reinforced with chemical protective coatings neat resin and/or fabrics synthetic materials.

In some implementations, the body portion has a central conduit for receiving a pin. The pin can have a stem extending through the conduit and a ring at an upper extremity of the stem. The pin can further include a fastener provided at a lower end of the stem for fastening the pin to the body portion. The pin can further include flanges contacting the upper and lower surfaces of the body portion. Optionally, the pin may be composed of stainless steel.

Optionally, the body portion may include ridges arranged in spaced relation to each other along a length of the body portion.

In other implementations, the central conduit passes partially through a center of the body portion to receive a connector member.

In other implementations, the plug may include a nut assembly having a nut canalization, the nut assembly being sunk in the plug so as to align the nut canalization and the central conduit.

In some implementations, the reinforcement structure may include an upper element having an annular cross-section and a lower flange element extending outward from a lower part of the upper element.

In some implementations, the anchor aperture may include a canalization used to inert lifting elements; and an anchor fastener mounted about the base and/or the walls of the cell, the anchor fastener having a body defining the canalization.

Optionally, the body may be a nut. The anchor fastener may further comprise a distal plate provided at a distal end of the body, and a proximal flange provided about a proximal portion of the body.

In some implementations, the plug may be configured to be inserted into the canalization of the anchor aperture, the plug having a body portion with an outer surface that contacts the corresponding canalization in a fluid-sealing fashion.

In some implementations, the canalization may be threaded to inert the lifting elements by bolting or screwing.

In some implementations, the anchor fastener may be embedded within or welded onto the wall or the base of the electrolytic cell.

In some implementations, the anchor assembly may include projections extending out of the walls or base.

In some implementations, the anchor assembly may have a structure to provide a flush surface with respect to an interior surface of the surrounding wall and/or base.

In some implementations, at least one of the rectangular base and four walls may include a reinforcement assembly which is embedded therein and configured to provide structural support proximal to each anchor assembly. Optionally, both rectangular base and four walls comprise the reinforcement assembly so as to provide structural support to each anchor assembly of the electrolytic cell assembly. Further optionally, the reinforcement assembly may include a plurality of elongated rebars. The plurality of elongated rebars may include at least one pair of opposed rebars which are space apart from each other to confine a corresponding anchor assembly.

Optionally, each anchor assembly of the electrolytic cell assembly may be located between two opposed rebars. One pair of opposed rebars may confine a first and second anchor assembly between a proximal end and a distal end of the rebars respectively.

In another implementation, there is provided a method for lifting an electrolytic cell assembly for hydrometallurgical refining of metal as defined above. The method includes coupling a lifting mechanism to the anchor apertures; and vertically lifting the electrolytic cell assembly to a lifted position.

In some implementations, the coupling may include screwing or bolting a lifting element within each anchor aperture. In other implementations, the coupling may include passing a lifting element through each anchor aperture. The lifting element may be a strap, belt, or analogs thereof, the lifting element being pulled by a lifting machine.

In some implementations, the method may include removing the plug and/or protective layer from each anchor aperture, before the coupling step. Optionally, removing the plugs can include hammering each plug from an outer side of the wall or base of the cell. Further optionally, removing the plugs can include pulling each plug out of the corresponding anchor aperture from an inner side of the wall or base of the cell. Further optionally, removing the plugs can include unscrewing each plug from the corresponding anchor aperture. Further optionally, removing the plugs and/or protective layers can include breaking each plug and/or each protective layer

In some implementations, the method may include draining the electrolysis cavity.

In some implementations, the method may include conducting maintenance of the electrolytic cell while the electrolytic cell assembly is in the lifted position.

### BRIEF DESCRIPTION OF DRAWINGS

Embodiments of the electrolytic cell assembly and related methods are represented in and will be further understood in connection with the following figures.

FIG. 1 is a cross-sectional view of a series of adjacent cells in close proximity.

FIG. 2 is a zoomed view of a portion of FIG. 1 showing that the cells are in close proximity laterally.

FIGS. 3 and 4 are respectively a top view and a semi-transparent side view of an electrolytic cell assembly including an anchor aperture at each of the four corners of the electrolytic cell.

FIG. 5 is a semi-transparent side view of an electrolytic cell assembly including four anchor assembly in each of the two lateral walls of the electrolytic cell.

FIGS. 6 to 9 are schematic cross-sectional view of three adjacent cells during a lifting process.

FIG. 10 is a cross-sectional front view of an electrolytic cell assembly including anchor assemblies within a base thereof.

FIG. 11 is a zoomed view of a portion of FIG. 10 showing an anchor assembly.

FIG. 12 is a perspective view of a reinforcement structure of an anchor aperture.

FIG. 13 is a side view of the reinforcement structure of FIG. 12.

FIGS. 14 and 15 are cross-sectional views of two implementations of the reinforcement structure of FIG. 12. FIG. 15 illustrates a rounded edge 26.

FIG. 16 is a top view of an electrolytic cell assembly having four anchor assemblies within the base.

FIGS. 17 and 18 are a zoomed top view and cross-sectional view respectively of a portion of FIG. 16 showing that the anchor assembly can include a protective layer.

FIG. 19 is a cross-sectional front view of an electrolytic cell assembly including an anchor fastener.

FIG. 20 is a zoomed view of a portion of FIG. 19 showing the anchor fastener embedded within the wall.

FIG. 21 is a perspective view of the anchor fastener from FIGS. 19 and 20.

FIG. 22 is a cross-sectional view of the anchor fastener of FIG. 21.

FIG. 23 is a schematic drawing of an end portion of belt including a connector member adaptable to some implementations of the anchor assembly described herein.

FIG. 24 is a perspective view of a plug from an electrolytic cell assembly.

FIG. 25 is a bottom view of the plug of FIG. 24.

FIG. 26 is a cross-sectional view of the plug of FIG. 24.

FIG. 27 is a cross-sectional side partial view of an electrolytic cell assembly showing a plugged anchor aperture.

FIG. 28 is a zoomed view of a portion of FIG. 27.

FIGS. 29 and 30 are a bottom view and a cross-sectional view respectively of a plug from an electrolytic cell assembly.

FIGS. 31 and 32 are a perspective view and a cross-sectional view respectively of a plug from an electrolytic cell assembly.

FIG. 33 is a perspective view of a plug from an electrolytic cell assembly.

FIGS. 34 and 35 are cross-sectional side view and semi-transparent view respectively of the plug of FIG. 33.

FIG. 36 is a perspective view of a nut assembly sinkable in a plug.

FIG. 37 is a side view of the nut assembly of FIG. 36.

FIG. 38 is a bottom view of the nut assembly of FIG. 36.

FIG. 39 is a top view of the nut assembly of FIG. 36.

FIG. 40 is a semi-transparent top view of an electrolytic cell assembly including a reinforcement assembly comprised of rebars.

FIG. 41 is a semi-transparent front view of an electrolytic cell assembly including a reinforcement assembly comprised of rebars.

FIG. 42 is a perspective view of an electrolytic cell assembly during lifting.

FIG. 43 is a semi-transparent perspective view of a portion of the cell assembly of FIG. 42 showing a strap through a pair of anchor apertures.

FIG. 44 is cross-sectional view of an electrolytic cell assembly during lifting thereof showing a strap through a pair of anchor apertures.

FIG. 45 is a zoomed view of a portion of FIG. 44 showing the strap wrapped on a reinforcement structure of the anchor aperture.

The objects, advantages and other features of the present techniques will become more apparent and be better understood upon reading of the following non-restrictive description, given with reference to the accompanying drawings.

### DETAILED DESCRIPTION

Techniques presented herein enable use of an anchoring assembly ensuring operative connection between an electrolytic cell and any lifting mechanism to facilitate vertical displacement of said electrolytic cell, for example during maintenance or reparation operations.

Implementations of the invention encompass the anchor assembly, an electrolytic cell assembly including the anchor assembly, the use of the anchor assembly to facilitate vertical displacement of the electrolytic cell and methods for vertically displacing the electrolytic cell via the anchoring assembly. The anchor assembly includes one or more anchor elements which can have various locations, arrangements, constructions, and utilizations in the context of facilitating lifting of electrolytic cells that are in cramped or difficult to access locations in hydrometallurgical refining facilities.

There is provided an electrolytic cell assembly including an electrolytic cell, which has a base and walls extending upward from the base, and at least one anchor assembly within the walls and/or the base of the electrolytic cell to enable vertical lifting or displacement thereof.

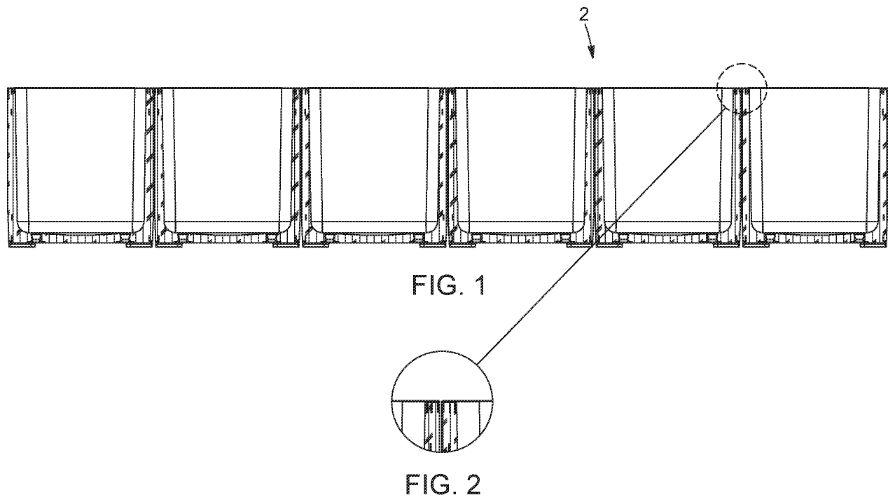

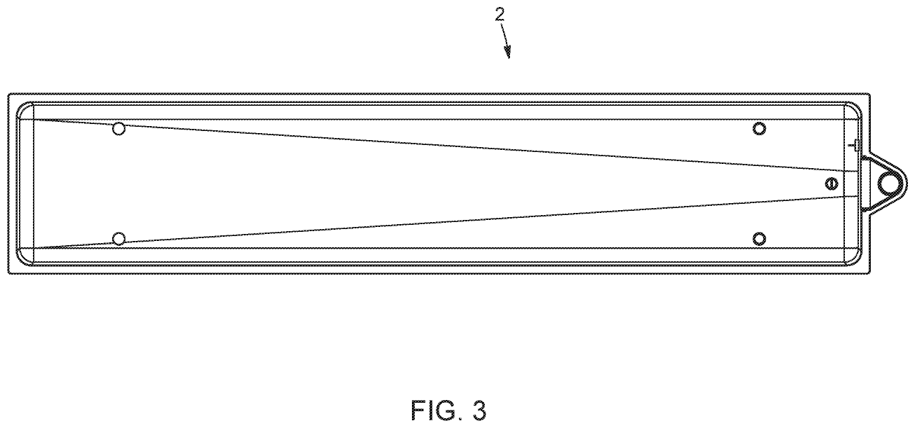

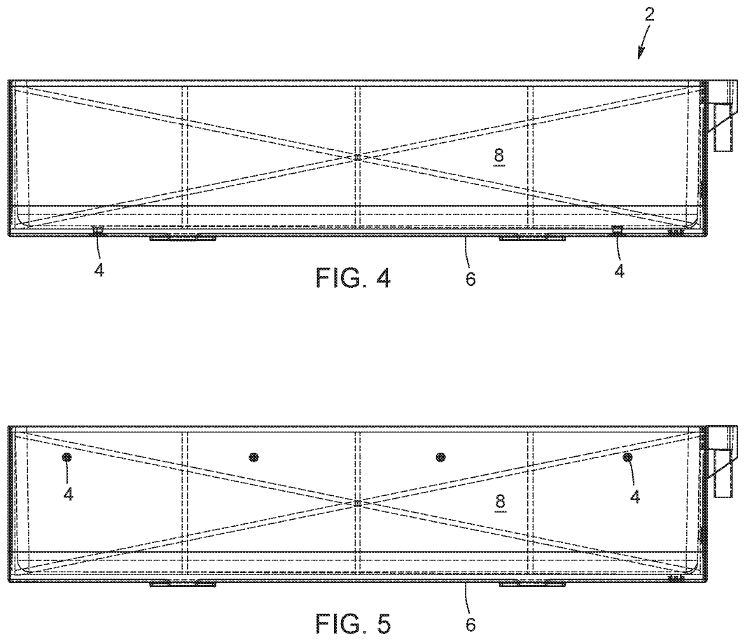

FIGS. 1 to 5 illustrate various possible locations of the anchor assemblies. Due to the close proximity of two adjacent electrolytic cells as seen on FIGS. 1 and 2, insertion of lifting elements in between the cells may be very difficult and may lead to damaging the cells. Advantageously, at least two anchor assemblies 4 may be provided within a base 6 of the electrolytic cell assembly 2 (see FIGS. 3 and 4) and/or within a wall 8 of the of the electrolytic cell assembly 2 (see FIG. 5) to enable vertical lifting or displacement thereof. FIGS. 3 and 4 show an implementation of the electrolytic cell assembly 2 including four anchor assemblies 4, arranged in two pairs of opposed anchor assemblies 4 within the base 6 of the cell assembly 2. FIG. 5 shows an implementation of the electrolytic cell assembly 2 including four anchor assemblies 4 within each lateral wall 8 of the cell assembly 2. It should be noted that the anchor assembly is located and designed so as to be at least accessible from the inside of the electrolytic cell.

It should be noted that the anchor assembly can be positioned at certain locations of the walls and/or base in accordance with preferred access of the lifting mechanism. For example, if the base is more accessible, the anchor assembly can be provided in the base only (e.g., at the four corners). If the walls are more accessible, the anchor assembly can be provided in the walls only (e.g., multiple ones in each wall, or multiple ones in the two opposed longer walls and none in the end walls). It should also be noted that anchor assembly can be provided in both walls and the base at specific locations (e.g., four corners of the base, and central location in each wall, offset or spaced away from the base anchor elements to distribute the lifting force).

There is provided an anchor assembly including an anchor aperture provided in a wall or base of an electrolytic cell. It should be noted that aperture may be understood as an opening, a canalization or a canal, which may be for example threaded, extending from an inner side of the wall and/or base outwardly towards an outer side of the wall and/or base. The canalization may completely extend from one side to the other so as to form a see-through aperture, alternatively extend from the inner side unto a point within the wall or base so as to form a cavity.

The anchor assembly can include a plug sized and shaped to be fitted within the anchor aperture. Optionally, the plug is designed to hermetically seal the anchor aperture and avoid leakage of the electrolytic solution. The anchor assembly can include a protective layer covering at least the anchor aperture so as to hermetically seal the anchor aperture and avoid leakage of the electrolytic solution. Lifting techniques may include removal of the plug and/or protective layer and using the opened anchor aperture to inert lifting elements that are coupled to lifting machinery for lifting the electrolytic cell assembly.

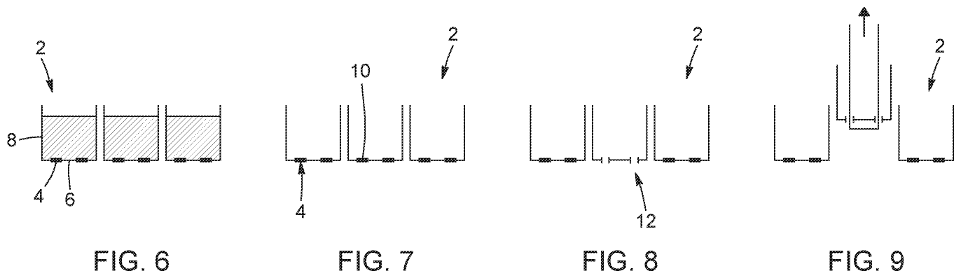

For example, FIGS. 6 to 9 show basic steps for lifting an electrolytic cell equipped with a pair of anchor assemblies. FIG. 6 is a schematic cross-sectional view of an electrolytic cell assembly 2 including a pair of opposed anchor assemblies 4 located within the base 6 proximate to each wall 8, and containing an electrolytic solution. Lifting techniques include removal of the plug 10 which seals the aperture 12 as seen on FIGS. 7 and 8. A lifting element, for example a belt as seen on FIG. 9, can be inserted through the unplugged apertures 10 and fastened to a lifting machinery (not illustrated) so as to lift one or more cells off of the floor.

### Anchoring Aperture Implementations

### Reinforcement Structure

In some implementations, the anchor assembly may further include a reinforcement structure to provide strength to the anchor aperture which is subjected to a lot of stress when in use for lifting. The reinforcement structure may be configured to define a central opening for the anchor aperture. The reinforcement structure can be designed and manufactured to have a shape corresponding to the plug, as illustrated in various figures. It should be noted that the reinforcement structure can be composed of various reinforcing materials, such as high compression concrete, fibreglass, or other compounds with very high anticorrosive and electrical insulating properties.

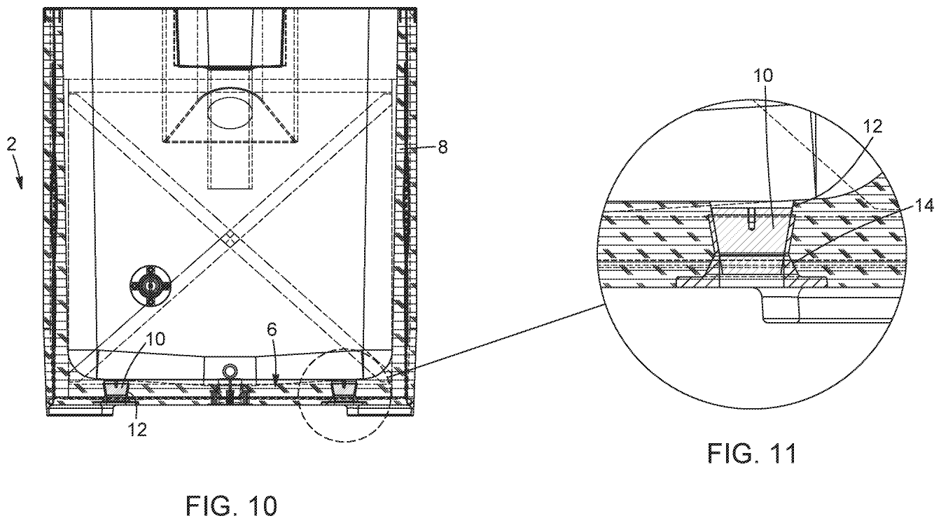

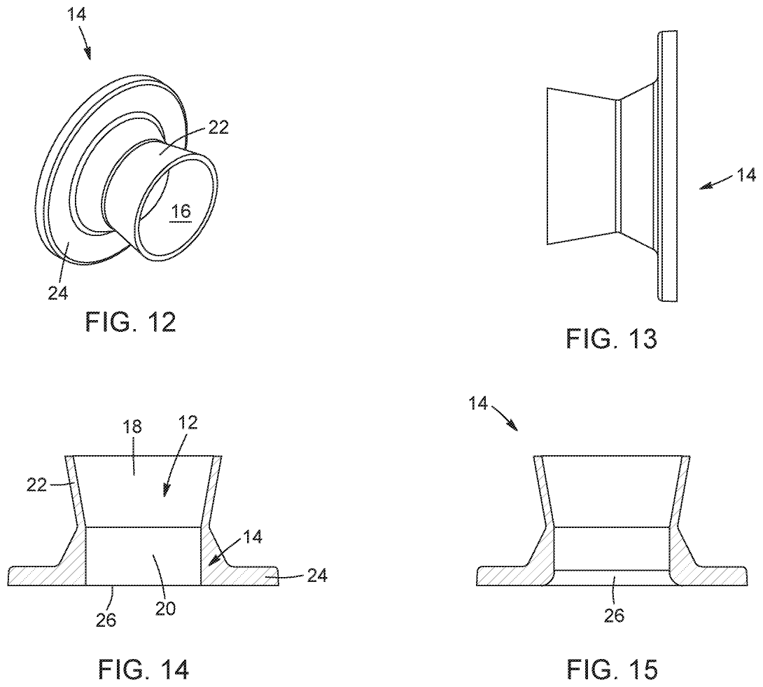

For example, the reinforcement structure that defines the opening can be constructed to have two frusto-conical parts to provide a general hourglass shape. This construction facilitates supporting the force required for lifting the cell assembly during lifting and displacement operations, and also to handle the pressures involved when the cell is full of liquid electrolyte during electrolysis operations. Thus, the two opposed cone structures facilitate distributing and handling the upward force of lifting as well as the downward force of the electrolyte. FIGS. 10 and 11 illustrate an anchor aperture 12 having a substantially hourglass shape, located within each of the four corners of the base 6 of the cell assembly 2. As better seen on FIG. 14, each anchor aperture 12 can have an upper portion 18 having a frusto-conical shape tapering outward in the upward direction; and a lower portion 20 having a cylindrical opening. As better seen on FIG. 12, the reinforcement structure 14 can have an upper element 22 having an annular cross-section and a lower flange element 24 extending outward from a lower part of the upper element 22. FIG. 15 illustrates that the opening can have rounded edges 26, which can facilitate distributing forces when in contact with lifting members, thus reducing the likelihood of the edge cutting into straps, cables or ropes that may be used for lifting. The rounded edges thus provide advantages compared to the sharp-edged embodiment of FIG. 14.

### Anchor Fastener

In other implementations, the anchor assembly may include an anchor fastener which can be embedded in the concrete of the cell walls or base, and can also be welded with respect to internal structures of the cell to secure the fastener with respect to the cell structure. The anchor fastener can include an anchor nut, and may further included a corresponding anchor bolt. One skilled in the art will know that a bolt is to be understood as a threaded fastener (male thread) which is used to bolt things together with a corresponding nut (female thread). The embedded nut has a canalization that optionally receives a nut plug.

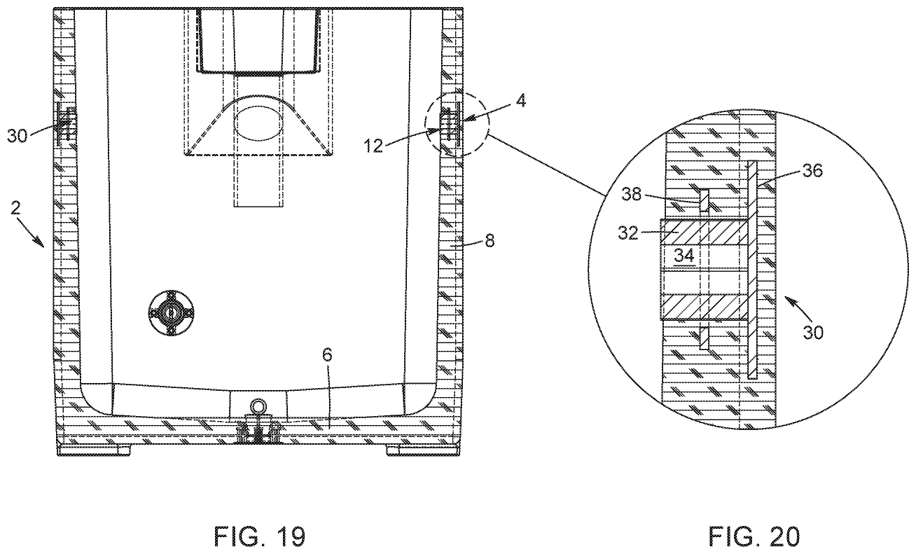

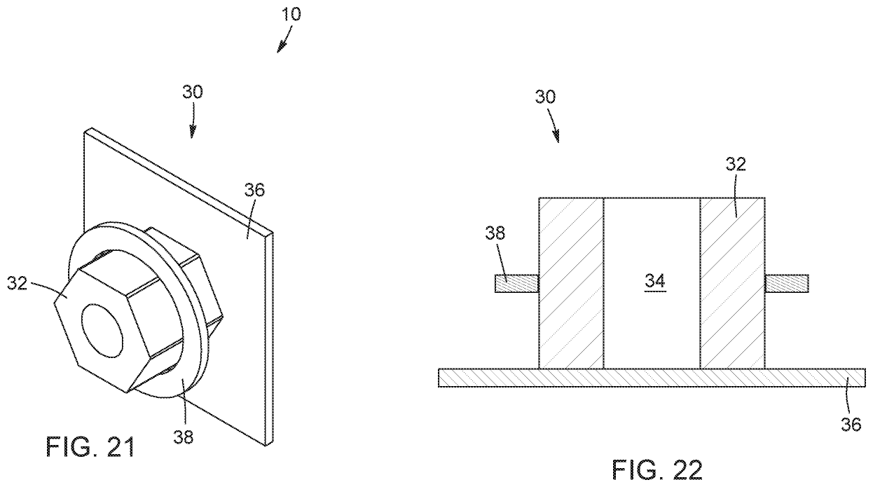

An exemplary anchor fastener 30 is shown in FIGS. 19 to 22. The anchor fastener 30 includes a nut 32 having an elongated body sized an shaped to define a nut canalization 34. The canalization can include an attachment mechanism, such as threads for screw or bolt fitting a lifting element within the canalization (not seen in the Figures). The anchor fastener 30 can also include a distal plate 36 (e.g., square plate) and a proximal flange 38 (e.g., annular circular plate) which are embedded within the wall 8 of the cell. The distal plate 36 can prevent the anchor fastener to destroy the wall or base. Both distal plate and proximal flange may further contribute to alleviate the mechanical stress imposed to the wall, base and/or aperture when the cell is lifted.

In use, each nut plug is removed from electrolytic cell assembly and the canalization of the embedded nut can be used to inert lifting elements that are coupled to lifting machinery. Thus, the cell assemblies can be connected to lifting machinery and lifted out of cramped quarters in order to maintain, repair or replace the cell. The nut plugs can be made in various ways and may have various compositions and structures for sealing off the nut canalization from the electrolyte during operation.

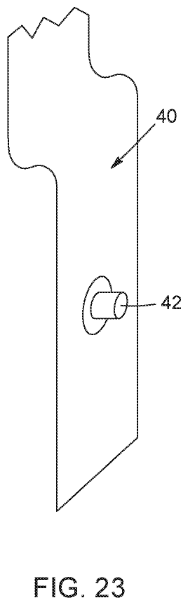

For example, as seen on FIG. 23, a strap member or belt 40 may be anchored to the anchor fastener by inserting a connector 42, such as a bolt, into the nut canalization of the anchor fastener. It should be noted that the strap member may be equipped with any connector element mounted thereto that can be configured for insertion, connection or other cooperation with the anchor aperture.

Referring back to FIG. 10, it is noted that the central aperture provided within the base can be a drain that is conventionally provided on such cells but a single drain cannot enable lifting or adequate handling of the cell for various desired operations.

### Plug Implementations

In some implementations, plugs are provided for plugging the anchor apertures to seal the electrolysis cavity during hydrometallurgical refining. Each plug can have a body portion with an outer surface that sealingly contacts the corresponding anchor aperture, i.e., contacts the aperture to form a fluid tight seal.

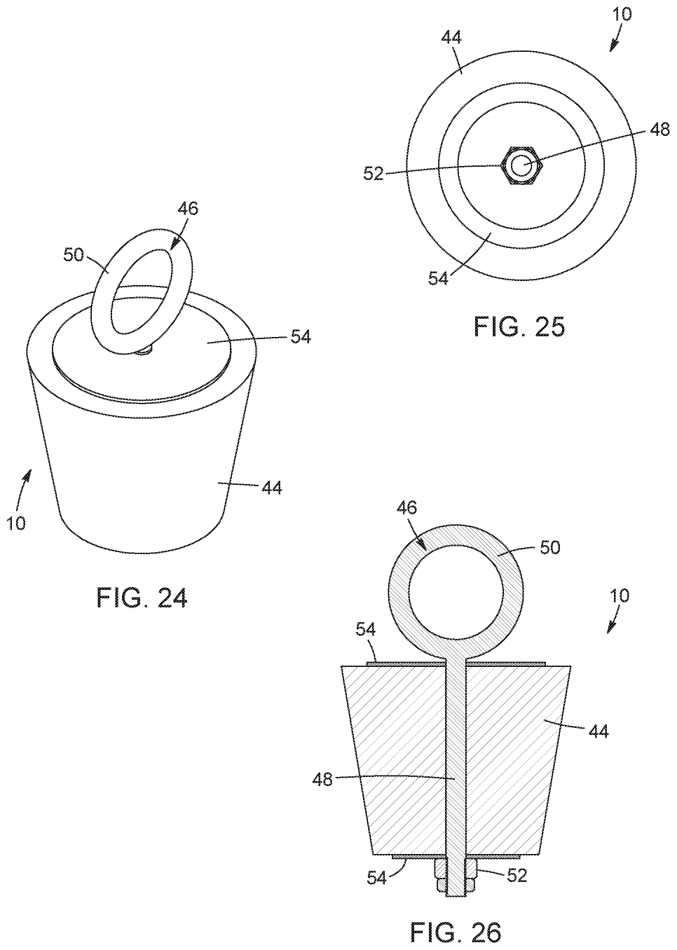

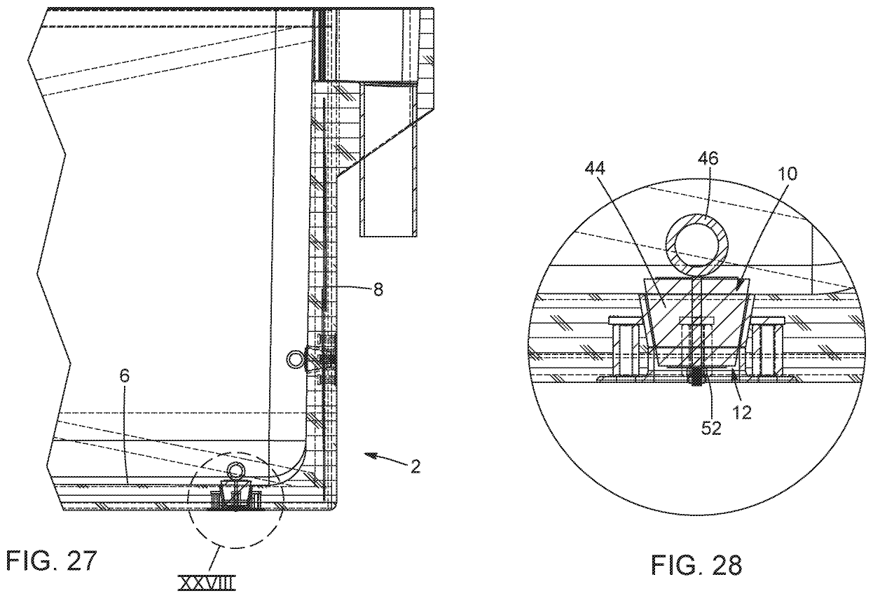

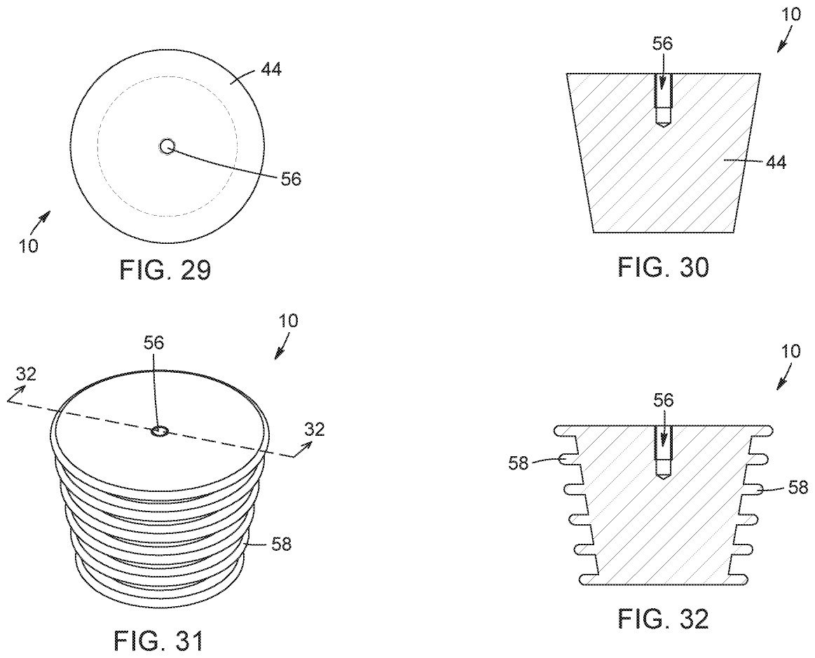

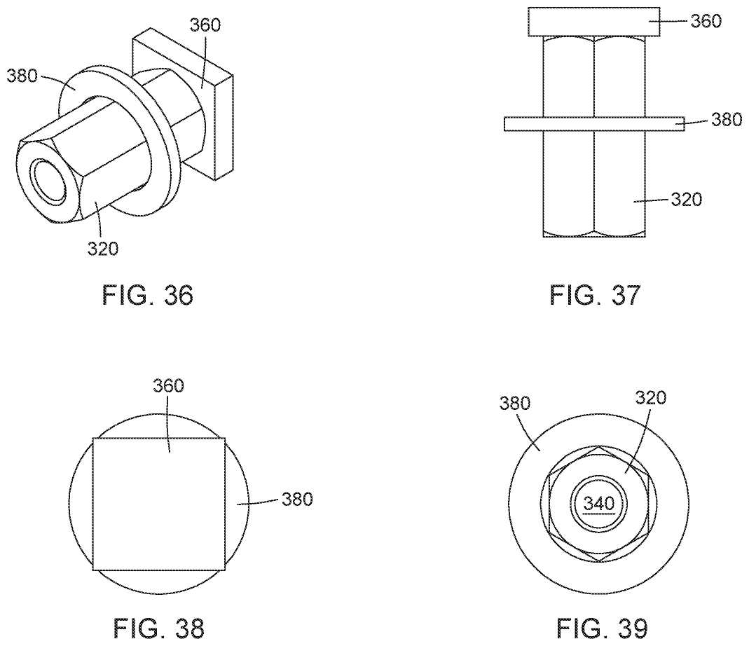

FIGS. 24 to 28 illustrate a first implementation of a plug from an anchor assembly. FIGS. 29 and 30 illustrate a second implementation of a plug from an anchor assembly. FIGS. 31 and 32 illustrate a third implementation of a plug from an anchor assembly. FIG. 34 to 39 illustrate a fourth implementation of a plug from an anchor assembly.

Referring to FIGS. 24 to 28, the plug 10 includes a body portion 44 having a central conduit for receiving a pin 46. The pin 46 can have a stem 48 extending through the conduit and a ring 40 at an upper extremity of the stem, and can include a fastener 52 (e.g., one or more nuts) provided at a lower end of the stem 48 for fastening the pin 46 to the body portion 44. The plug 10 can also include flanges 54 (e.g., disks or washers) contacting the upper and lower surfaces of the body portion 46. The nuts 52 can be used to compress the body portion 46 in between the two opposed disks 54 and bring the ring 50 flush against the upper disk 54, thereby securing the plug 10 within the anchor aperture 12. The pin and its subcomponents can be composed of stainless steel.

In some scenarios, as illustrated in FIGS. 29 and 30, the body portion 44 of the plug 10 can include a conduit 56 passing partially through the center of the body 44 for receiving a connector pin (not illustrated), rather than having a pin pass all the way through the body as per FIGS. 24 to 28.

In other implementations, referring to FIGS. 31 and 32, the body portion 44 can have ridges 58 arranged in spaced relation to each other along a length of the body portion 44. The ridges 58 and the central part of the body 44 can form an integral and one-piece structure. Optionally, as illustrated, the ridges 58 can be evenly spaced apart from one another. To ensure an adequate fitting of the body portion within the anchor aperture, the ridges can include an upper ridge and a lower ridge that are respectively co-planar with the upper and lower surfaces of the body. Optionally, the ridges may be irregularly spaced. Optionally, the ridges may have rounded edges. It should noted that the anchor aperture design may be adapted to the plug design and vice-versa. For example, if the body portion has ridges, the anchor aperture will include corresponding threads, provided by an embedded nut as above-mentioned or other threaded system.

FIGS. 34 to 39 relate to another embodiment of the plug where a nut arrangement is sunk into the body portion 44 of the plug 10. The nut arrangement may be as defined above in relation to the anchor fastener, but hidden within the plug. The nut 320 is combined with a distal plate 360 and proximal flange 380. The nut canalization 340 is used to inert a bolt or any tool enabling to pull the plug out of the anchor aperture.

It should be noted that the design of the plug may be adapted to the shape of the anchor aperture. For example, the plug can have a general hourglass shape and can be casted within the anchor aperture using the same material as the wall or base. Optionally, a release agent, such as a wax material, may be used before casting the plug within the aperture to facilitate further removal of the plug when the cell will need maintenance.

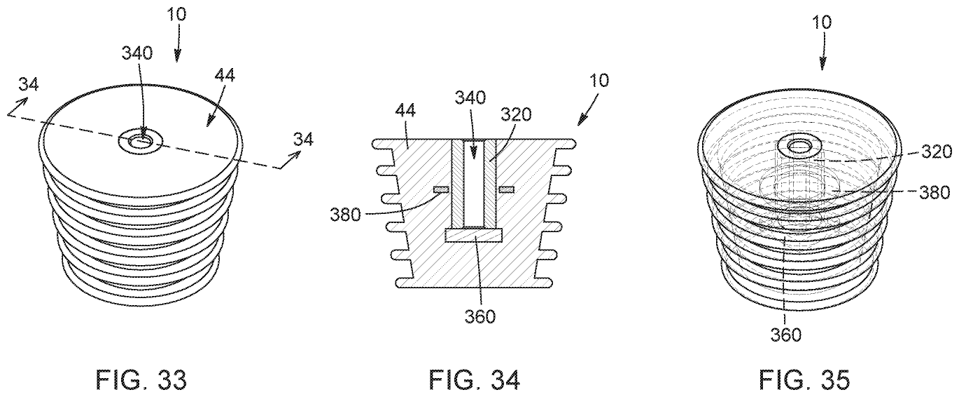

In some implementations, the plugs are provided to remain in place within the apertures for a certain amount of time before removal or replacement is desired. For example, plugs can be in place during operation for a period of 1 days to 2 years, after which the plugs can be removed and replaced with new plugs. In such scenarios, the removable plugs can be provided without glue or permanent anchoring within the cells, and can be removed during maintenance or cleaning of the cells, for example during periodic emptying of the cells. It should be noted that different types of plug may be used depending on the maintenance to be performed on the electrolytic cell, and/or depending on the time the plug will stay within the anchor aperture. For example, the plugs illustrated in FIGS. 29 to 32 may rather be used as short-term plugging whereas the plugs illustrated in FIGS. 33 to 35 may be used for long-term plugging.

When the plugs and anchor apertures are provided at locations that are in contact with electrolyte during refining operations, the construction and materials that are used should be selected to resist corrosion and the conditions of the electrolysis. Preferably, the plugs can be composed of rubber material (such as ethylene propylene diene monomer (M-class) rubber (EPDM)) or polymer concrete, and parts that are exposed to electrolyte are composed of anti-corrosive strong materials such as fibreglass (e.g., Fiberglas™), reinforced epoxy, Teflon, bisphenol F resin, or vinylester Fiberglas™ reinforced with chemical protective coatings neat resin and/or Fabrics synthetic materials. The plug can be made of the same material as the electrolytic cell walls and base, and casted or glued to the vessel.

### Protective Layer Implementations

In some implementations, the anchor assembly may include a protective layer, covering the anchor aperture, to further enable electrolysis operations. The protective layer can include one or more sub-layers of anticorrosive material(s).

The protective layer may include laminated material, which may include glass fiber based materials.

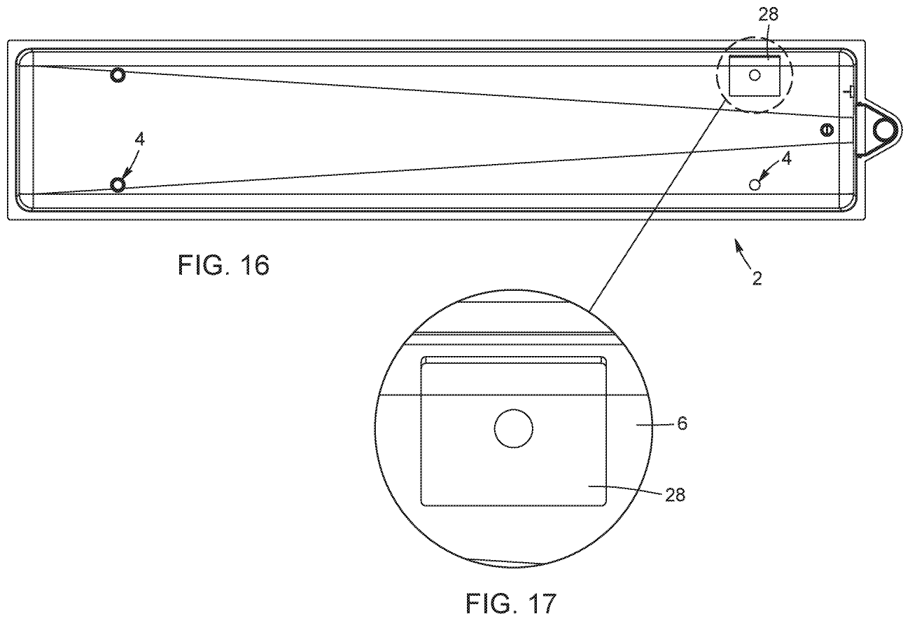

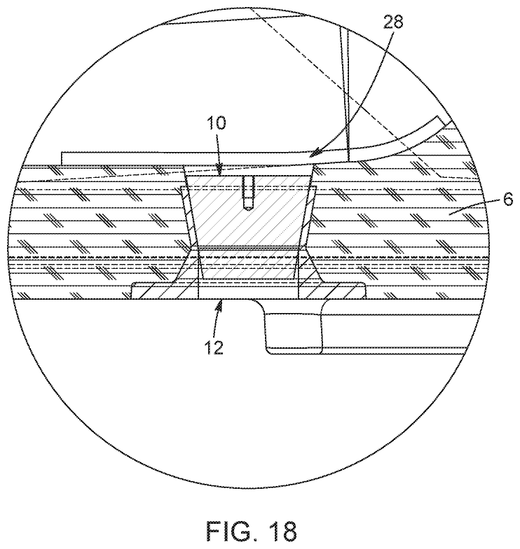

Referring to FIGS. 16 to 18, a protective layer 28 provided over a top of the plug 10 to provide additional protection with respect to the electrolyte (also referred to as electrolytic solution). As better seen on FIG. 18, the protective layer 28 may be provided in order to fully cover the anchor aperture 12 as well as surrounding adjacent surfaces of the cell base 6. A same configuration could be used for a protective layer located on the walls on the cell. It should be noted, as seen on FIG. 18, that part of the protective layer 28 may be on the flat base 6 and part may extend up the joint that forms the wall 8 of the cell.

It should further be noted that the protective layer may be configured to be used in combination with the anchor aperture so as to hermetically seal the aperture without the need for a plug (not illustrated in the Figures). Maintenance of the electrolytic cell will imply removal of the protective layer to release the anchor aperture.

### Other Reinforcement

In some implementations, the rectangular base and/or the four walls of the electrolytic cell assembly is provided with a reinforcement assembly so as to alleviate the load imposed to the anchor apertures, plugs or elements during lifting of the cell.

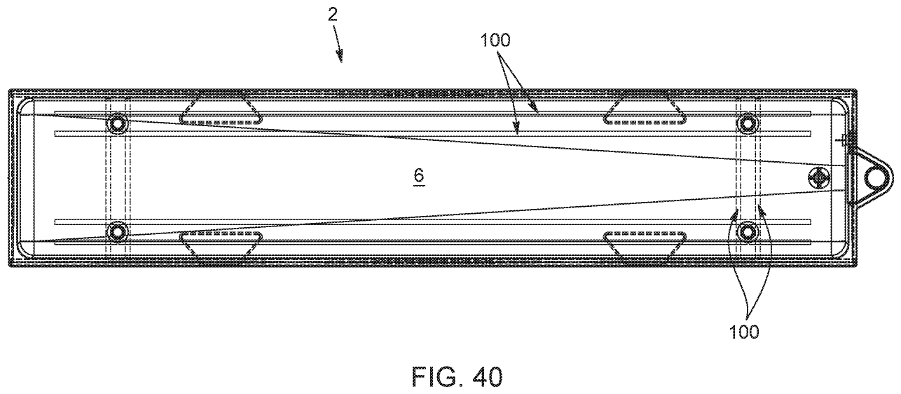

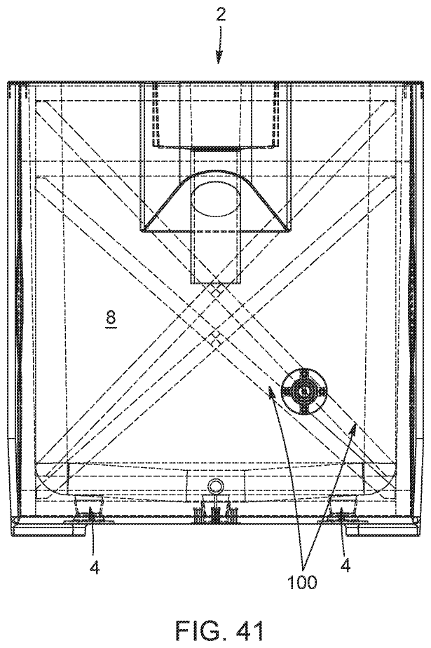

Referring to FIGS. 40 and 41, the base 6 and/or four walls 8 may include a plurality of elongated rebars 100 which is embedded therein and configured to provide structural support proximal to the anchor assemblies 4. The elongated rebars 100 may be arranged in pairs of opposed rebars 100 which are spaced apart from each other so as to confine at least one of the anchor apertures. For example, as better seen on FIG. 40, each anchor apertures is located between at least one pair of rebars at each corner of the rectangular base. Two pairs of opposed rebars 100 may also be embedded in the walls in a cross-like configuration.

### Method Implementations

In operation, the anchor assembly can be used to conduct maintenance, replacement or general handling, particularly when the cell is in an awkward or cramped location and/or is located in close proximity to other cells as seen in FIGS. 1 and 2.

For example, the following steps can be performed when the assembly is to be handled: removing the plug and/or protective layer from each anchor aperture; coupling a lifting mechanism to the anchor apertures; and vertically lifting the electrolytic cell assembly to a lifted position. Operators can also conduct maintenance while the electrolytic cell assembly is in the lifted position. Various machines and systems can be used for lifting the cells, and a connection mechanism can be adapted for coupling to the apertures. After handling the cell, plugs can be reinserted, re-glued and/or re-casted to enable functioning of the cell in hydrometallurgical refining processes. Additionally or alternatively, after handling the cell, a protective layer may be added to cover the anchor aperture.

FIGS. 6 to 9 illustrate an example where cells are installed in very close proximity preventing subsequent removal, operated for electrolysis, drained, and then the middle cell has its anchor apertures opened by removing the plugs, following which a lifting element is provided through the apertures in a lifting configuration and the middle cell is lifted out of the row. It is noted that cells are typically provided with space underneath, either due to being provided with feet (e.g., see FIGS. 1, 10 and 19 with bottom feet) or being provided on elevated support structures. Thus, lifting straps can be inserted through the anchor apertures and provided to have a lower support of the cells.

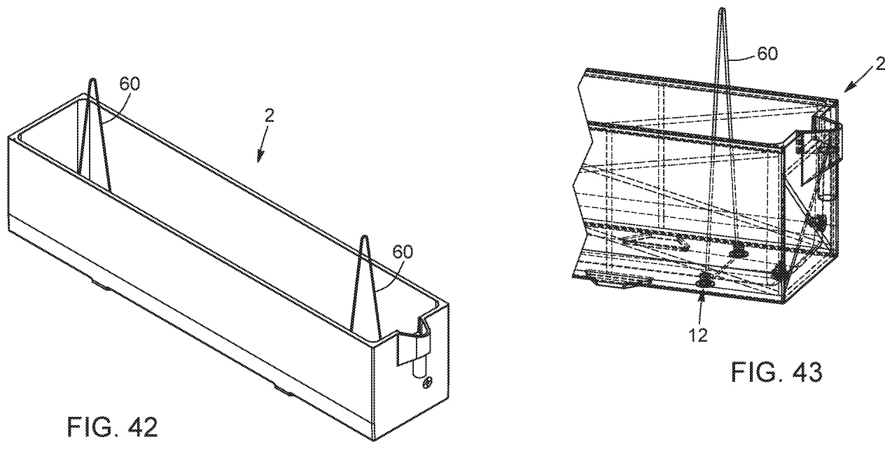

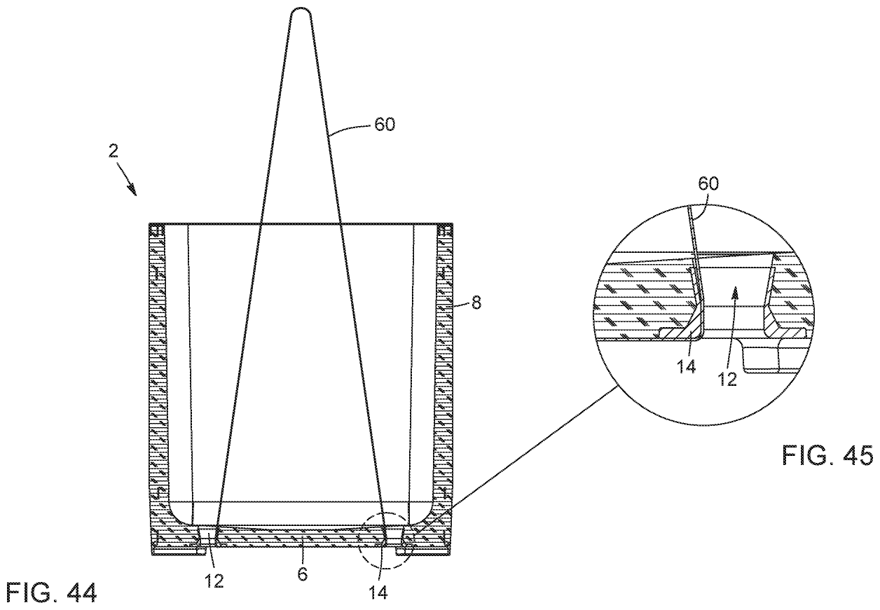

FIGS. 43 to 45 illustrate a lifting member 60 (e.g., a strap, belt or cable) positioned through a pair of anchor apertures 12, reinforced with a reinforcement structure 14, and extending below the bottom of the cell. FIG. 45 shows that the strap 60 can follow the contour of the round-edged reinforcement structure 14 which can define the opening 12 through which the straps are inserted. As shown in FIG. 42, pairs of apertures 12 can be used for each elongate lifting member 60 (e.g., strap) and provided at or near adjacent corners.

It should be noted that additional pairs of anchor apertures can be provided at other locations of the cell base, side walls. In addition, there are alternative arrangements for inserting the elongate lifting members other than the triangular arrangement where the two vertical parts are positioned within the cell cavity. For example, one vertical part can be located within the cavity and the other vertical part can be positioned outside of the cell at a forward or rearward wall; in such cases, the lifting member may be provided through a single aperture and may also engage the cell at the proximate edge (forward or rearward) between the base and the side wall. Other arrangements for the lifting members are also possible. In addition, in some scenarios, the lifting members may be rigid structural elements rather than flexible like straps or cables, and in such cases the lifting members can engage the anchor elements in other ways.

Thus, when there is significant damage to one of the cells, the operator can expose the anchor point by breaking the protective layer and/or removing the plug or other covering mechanisms or layers. Removal of the plug can be performed by hammering from below, and due to its conical structure the plug can be displaced upwardly and removed. A release agent may be used before inserting or casting the plug to ease subsequent removal. Alternatively, the plugs can be removed by pulling with a threaded eyelet, in which case there may be an inserted nut into the plug.

In some cases, the plug can be impacted in order to break the plug when it is made of a breakable material. For example, when the plugs have been casted within the anchor aperture using polymer concrete as the same material as the wall or base of the cell, plug breaking may be necessary to ensure adequate removal. In some cases, a cell is only temporarily damaged and can be repaired. In such scenarios, the damaged cell can be removed according to techniques described herein, and a new cell can be rapidly installed to continue electrolysis and metals production while the damaged cell is repaired or inspected in an appropriate area rather than at the production area.

It should also be noted that other structures can be used for anchor assembly elements, such as projections that extend out of the cell wall or base structure and are protected by a cap or similar covering during electrolysis operation. However, it is preferred that the anchor assemblies have a structure enabling flushness with the interior surface of the cell walls and/or base. In addition, the plug can be provided with sealing joints (e.g., hydraulic cylinder, which may be composed of Teflon seals).

It should be understood that any one of the above mentioned optional aspects of the methods may be combined with any other of the aspects the electrolytic cell assembly, unless two aspects clearly cannot be combined due to their mutually exclusivity. For example, the various operational steps of the methods described herein may be combined with any of the anchor aperture, plug or protective layer descriptions appearing herein and/or in accordance with the appended claims.

1. An electrolytic cell assembly for hydrometallurgical refining of metal, comprising:
an electrolytic cell comprising:
a rectangular base for contacting a floor, and
four walls extending upward from the rectangular base and defining an electrolysis cavity for receiving electrolyte and electrodes; and
at least two anchor assemblies for lifting the electrolytic cell assembly off of the floor, each anchor assembly comprising an anchor aperture located in the base and/or the walls for providing anchor points.

2. (canceled)

3. (canceled)

4. The electrolytic cell assembly of claim 1, wherein each anchor assembly further comprises a protective layer for covering at least the anchor aperture and sealing the electrolysis cavity during hydrometallurgical refining.

5. (canceled)

6. (canceled)

7. (canceled)

8. The electrolytic cell assembly of claim 1, wherein each anchor assembly further comprises a plug for plugging the anchor aperture and sealing the electrolysis cavity during hydrometallurgical refining.

9. The electrolytic cell assembly of claim 1, wherein the anchor aperture comprises:
a central opening used to inert lifting elements; and
a reinforcement structure defining the central opening.

10. (canceled)

11. (canceled)

12. (canceled)

13. The electrolytic cell assembly of claim 1, wherein the plug has a body portion with an outer surface that contacts the corresponding anchor aperture in a fluid-sealing fashion.

14. (canceled)

15. The electrolytic cell assembly of claim 13, wherein the body portion has a central conduit for receiving a pin which comprises a fastener provided at a lower end of a stem for fastening the pin to the body portion.

16. (canceled)

17. (canceled)

18. (canceled)

19. (canceled)

20. The electrolytic cell assembly of claim 15, wherein the central conduit passes partially through a center of the body portion to receive a connector member.

21. The electrolytic cell assembly of claim 15, wherein the plug comprises a nut assembly having a nut canalization, the nut assembly being sunk in the plug so as to align the nut canalization and the central conduit.

22. (canceled)

23. (canceled)

24. The electrolytic cell assembly of claim 1, wherein the anchor aperture comprises:
a canalization used to inert lifting elements; and
an anchor fastener mounted about the base and/or the walls of the cell, the anchor fastener having a body defining the canalization.

25. (canceled)

26. The electrolytic cell assembly of claim 24, wherein the anchor fastener further comprise a distal plate provided at a distal end of the body, and a proximal flange provided about a proximal portion of the body.

27. The electrolytic cell assembly of claim 24, wherein a plug is configured to be inserted into the canalization of the anchor aperture, the plug having a body portion with an outer surface that contacts the corresponding canalization in a fluid-sealing fashion.

28. (canceled)

29. The electrolytic cell assembly of claim 24, wherein the anchor fastener is embedded within or welded onto the wall or the base of the electrolytic cell.

30. (canceled)

31. The electrolytic cell assembly of claim 1, wherein the anchor assembly has a structure to provide a flush surface with respect to an interior surface of the surrounding wall and/or base.

32. The electrolytic cell assembly of claim 1, wherein at least one of the rectangular base and four walls comprise a reinforcement assembly which is embedded therein and configured to provide structural support proximal to each anchor assembly.

33. (canceled)

34. The electrolytic cell assembly according to claim 32, wherein the reinforcement assembly comprise a plurality of elongated rebars which are space apart from each other to confine a corresponding anchor assembly.

35. (canceled)

36. (canceled)

37. (canceled)

38. A method for lifting an electrolytic cell assembly for hydrometallurgical refining of metal as defined in claim 1, the method comprising:
coupling a lifting mechanism to the anchor apertures; and
vertically lifting the electrolytic cell assembly to a lifted position.

39. The method of claim 38, wherein the coupling includes screwing or bolting a lifting element within each anchor aperture.

40. The method of claim 38, wherein the coupling includes passing a lifting element through each anchor aperture.

41. The method of claim 40, wherein the lifting element is a strap, belt, or analogs thereof, the lifting element being pulled by a lifting machine.

42. The method of claim 38, comprising removing the plug and/or protective layer from each anchor aperture, before the coupling step.

43. (canceled)

44. (canceled)

45. (canceled)

46. (canceled)

47. (canceled)

48. (canceled)
